(19) United States
(12) Patent Application Publication
(10) Pub. No.: US 2011/0310005 A1
(43) Pub. Date: Dec. 22, 2011

(54) METHODS AND APPARATUS FOR CONTACTLESS GESTURE RECOGNITION

(75) Inventors: An M. Chen, San Diego, CA (US); Heng-Tze Cheng, Palo Alto, CA (US); Ashu Razdan, San Diego, CA (US); Elliot B. Buller, Carlsbad, CA (US)

(73) Assignee: QUALCOMM Incorporated, San Diego, CA (US)

(21) Appl. No.: 13/161,955

(22) Filed: Jun. 16, 2011

Related U.S. Application Data
(60) Provisional application No. 61/355,923, filed on Jun. 17, 2010.
(60) Provisional application No. 61/372,177, filed on Aug. 10, 2010.

(51) Int. Cl. G09G 5/00

(52) U.S. Cl. 345/156

(57) ABSTRACT

Systems and methods are described for performing contactless gesture recognition for a computing device, such as a mobile computing device. An example technique for managing a gesture-based input mechanism for a computing device described herein includes identifying parameters of the computing device relating to accuracy of gesture classification performed by the gesture-based input mechanism and managing a power consumption level of at least an infrared (IR) light emitting diode (LED) or an IR proximity sensor of the gesture-based input mechanism based on the parameters of the computing device.

### CROSS-REFERENCES TO RELATED APPLICATIONS

This application claims priority to U.S. Provisional Patent Application No. 61/355,923, filed Jun. 17, 2010, entitled “METHODS AND APPARATUS FOR CONTACTLESS GESTURE RECOGNITION,” Attorney Docket No. 102222P1, and U.S. Provisional Patent Application No. 61/372,177, filed Aug. 10, 2010, entitled “CONTACTLESS GESTURE RECOGNITION SYSTEM USING PROXIMITY SENSORS,” all of which is hereby incorporated herein by reference for all purposes.

### BACKGROUND

Advancements in wireless communication technology have greatly increased the versatility of today's wireless communication devices. These advancements have enabled wireless communication devices to evolve from simple mobile telephones and pagers into sophisticated computing devices capable of a wide variety of functionality such as multimedia recording and playback, event scheduling, word processing, e-commerce, etc. As a result, users of today's wireless communication devices are able to perform a wide range of tasks from a single, portable device that conventionally required either multiple devices or larger, non-portable equipment.

As the sophistication of wireless communication devices has increased, so has the demand for more robust and intuitive mechanisms for providing input to such devices. While the functionality of wireless communication devices has significantly expanded, the size constrains associated with these devices renders many input devices associated with conventional computing systems, such as keyboards, mice, etc., impractical.

To overcome form factor limitations of wireless communication devices, some conventional devices use gesture recognition mechanisms to enable a user to provide inputs to the device via motions or gestures. Conventional gesture recognition mechanisms can be classified into various categories. Motion-based gesture recognition systems interpret gestures based on movement of an external controller held by a user. Touch-based systems map the position(s) of contact point(s) on a touchpad, touchscreen, or the like, from which gestures are interpreted based on changes to the mapped position(s). Vision-based gesture recognition systems utilize a camera and/or a computer vision system to identify visual gestures made by a user.

### SUMMARY

An example mobile computing device according to the disclosure includes a device casing; a sensor system configured to obtain data relating to three-dimensional user movements, where the sensor system includes an infrared (IR) light emitting diode (LED) and an IR proximity sensor; a gesture recognition module communicatively coupled to the sensor system and configured to identify an input gesture provided to the device based on the data relating to the three-dimensional user movements; and a sensor controller module communicatively coupled to the sensor system and configured to identify properties of the device indicative of clarity of the data relating to the three-dimensional user movements obtained by the sensor system and probability of correct identification of the input gesture by the gesture recognition module and to regulate power consumption of at least one of the IR LED or the IR proximity sensor of the sensor system based on the properties of the device.

Implementations of such a mobile computing device may include one or more of the following features. An ambient light sensor communicatively coupled to the sensor controller module and configured to identify an ambient light level of an area at which the device is located, where the sensor controller module is further configured to adjust a power level of the IR LED according to the ambient light level. An activity monitor module communicatively coupled to the sensor controller module and configured to determine a level of user activity with respect to the device, where the sensor controller module is further configured to regulate the power consumption of the sensor system according to the level of user activity.

Implementations of such a mobile computing device may additionally or alternatively include one or more of the following features. The sensor controller module is further configured to place the sensor system in a slotted operating mode if the level of user activity is determined to be below a predefined threshold. IR LEDs and IR proximity sensors of the sensor system are positioned on at least two front-facing edges of the device casing, the properties of the device include orientation of the device, and the sensor controller module is further configured to selectively activate IR LEDs and IR proximity sensors positioned on at least one front-facing edge of the device casing based on the orientation of the device. The device casing provides apertures positioned along at least one front-facing edge of the device casing and covered with an IR transmissive material, and one of an IR LED or an IR proximity sensor of the sensor system is positioned behind each of the apertures provided by the device casing. The IR LED and the IR proximity sensor of the sensor system are located inside the device casing, and the sensor system further includes risers respectively coupled to the IR LED and the IR proximity sensor such that the IR LED and the IR proximity sensor are elevated toward a surface of the device casing by the risers.

Further, implementations of such a mobile computing device may additionally or alternatively include one or more of the following features. A framing module communicatively coupled to the sensor system and configured to partition the data obtained by the sensor system into frame intervals, and a feature extraction module communicatively coupled to the framing module and the sensor system and configured to extract features from the data obtained by the sensor system, where the gesture recognition module is communicatively coupled to the framing module and the feature extraction module and configured to identify input gestures corresponding to respective ones of the frame intervals based on the features extracted from the data obtained by the sensor system. The gesture recognition module is further configured to identify the input gestures based on at least one of cross correlation, linear regression or signal statistics. The sensor system is configured to obtain the data relating to the three-dimensional user movements with reference to a plurality of moving objects.

An example of a method of managing a gesture-based input mechanism for a computing device according to the disclosure includes identifying parameters of the computing device relating to accuracy of gesture classification performed by the gesture-based input mechanism, and managing a power consumption level of at least an IR LED or an IR proximity sensor of the gesture-based input mechanism based on the parameters of the computing device.

Implementations of such a method may include one or more of the following features. The identifying includes identifying an ambient light level of an area associated with the computing device and the managing includes adjusting a power level of the IR LED according to the ambient light level. The identifying includes determining a level of user interaction with the computing device via the gesture-based input mechanism, and the managing includes comparing the level of user interaction to a threshold and placing the gesture-based input mechanism in a power saving mode if the level of user interaction is below the threshold. The identifying includes identifying an orientation of the computing device and the managing includes activating or deactivating the IR LED or the IR proximity sensor based on the orientation of the computing device. Obtaining sensor data from the gesture-based input mechanism, partitioning the sensor data in time, thereby obtaining respective frame intervals, extracting features from the sensor data, and classifying gestures represented in respective ones of the frame intervals based on the features extracted from the sensor data. The classifying includes classifying the gestures represented in the respective ones of the frame intervals based on at least one of cross correlation, linear regression or signal statistics. The obtaining includes obtaining sensor data relating to a plurality of moving objects.

An example of another mobile computing device according to the disclosure includes sensor means configured to obtain IR light-based proximity sensor data relating to user interaction with the device, gesture means communicatively coupled to the sensor means and configured to classify the proximity sensor data by identifying input gestures represented in the proximity sensor data, and controller means communicatively coupled to the sensor means and configured to identify properties of the device and to manage power consumption of at least part of the sensor means based on the properties of the device.

Implementations of such a mobile computing device may include one or more of the following features. The controller means is further configured to measure an ambient light level at an area associated with the device and to adjust the power consumption of at least part of the sensor means based on the ambient light level. The controller means is further configured to determine an extent of the user interaction with the device and to adjust the power consumption of at least part of the sensor means according to the extent of the user interaction with the device. The controller means is further configured to power off the sensor means upon determining that no user interaction with the device has been identified by the sensor means within a time interval. The controller means is further configured to place the sensor means in a power save operating mode if the extent of the user interaction with the device is below a threshold. The sensor means includes a plurality of sensor elements, and the controller means is further configured to selectively activate one or more of the plurality of sensor elements based on an orientation of the device.

An example of a computer program product according to the disclosure resides on a non-transitory processor-readable medium and includes processor-readable instructions configured to cause a processor to obtain three-dimensional user movement data from an IR proximity sensor associated with a mobile device that measures reflection of light from an IR LED, detect one or more gestures associated with the three-dimensional user movement data, identify properties of the mobile device indicative of accuracy of the three-dimensional user movement data, and regulate power usage of at least a portion of the IR LEDs and IR proximity sensors based on the properties of the mobile device.

Implementations of such a computer program product may include one or more of the following features. The parameters of the mobile device include an ambient light level at an area associated with the mobile device. The parameters of the mobile device include a history of user interaction with the mobile device. The parameters of the mobile device include an orientation of the mobile device. The instructions configured to cause the processor to detect the one or more gestures are further configured to cause the processor to group the three-dimensional user movement data according to respective frame time intervals, extract features from the three-dimensional user movement data, and identify input gestures provided within respective ones of the frame time intervals based on the features extracted from the three-dimensional user movement data. The instructions configured to cause the processor to identify input gestures are further configured to cause the processor to identify the input gestures based on at least one of cross correlation, linear regression or signal statistics.

Items and/or techniques described herein may provide one or more of the following capabilities, as well as other capabilities not mentioned. Contactless gesture recognition can be supported using proximity sensors. Three-dimensional gestures can be utilized and classified in real time. The energy consumption associated with gesture recognition can be reduced and/or controlled with higher granularity. The frequency of contact between a user and a touch surface can be reduced, alleviating normal wear of the touch surface and reducing germ production and transfer. Proximity sensors can be covered with sensor-friendly materials in order to improve the aesthetics of an associated device. Proximity sensors and associated emitters can be made highly resistant to interference from ambient light, unintentional light dispersion, and other factors. While at least one item/technique-effect pair has been described, it may be possible for a noted effect to be achieved by means other than that noted, and a noted item/technique may not necessarily yield the noted effect.

### BRIEF DESCRIPTION OF THE DRAWINGS

FIG. 1 is a block diagram of components of a mobile station.

FIG. 2 is a partial functional block diagram of the mobile station shown in FIG. 1.

FIG. 3 is a partial functional block diagram of a system for regulating an input sensor system associated with a wireless communication device.

FIG. 4 is a graphical illustration of a proximity sensor employed for gesture recognition.

FIG. 5 is a graphical illustration of an example gesture that can be recognized and interpreted by a gesture recognition mechanism associated with a mobile device.

FIG. 6 is an alternative block diagram of the mobile station shown in FIG. 1.

FIGS. 7-10 are graphical illustrations of further example gestures that can be recognized and interpreted by a gesture recognition mechanism associated with a mobile device.

FIG. 11 is a partial functional block diagram of a contactless gesture recognition system.

FIG. 12 is an alternative partial functional block diagram of a contactless gesture recognition system.

FIG. 13 is a flowchart illustrating a technique for decision tree-based gesture classification.

FIG. 14 is a flowchart illustrating an alternative technique for decision tree-based gesture classification.

FIG. 15 is a block flow diagram of a process of gesture recognition for a mobile device.

FIG. 16 is a graphical illustration of a proximity sensor configuration implemented for contactless gesture recognition.

FIG. 17 is a graphical illustration of alternative proximity sensor placements for a contactless gesture recognition system.

FIG. 18 is a graphical illustration of an additional alternative proximity sensor placement for a contactless gesture recognition system.

FIG. 19 is a graphical illustration of various proximity sensor configurations for a contactless gesture recognition system.

FIG. 20 is a block flow diagram of a process of managing a contactless gesture recognition system.

### DETAILED DESCRIPTION

Techniques are described herein for managing inputs to a wireless communication device via contactless gesture recognition. A contactless gesture recognition system utilizes infrared (IR) light emitters and IR proximity sensors for detection and recognition of hand gestures. The system recognizes, extracts and classifies three-dimensional gestures in a substantially real-time manner, which enables intuitive interaction between a user and a mobile device. Using the system as a gesture interface, a user can perform such actions as flipping e-book pages, scrolling web pages, zooming in and out, playing games, etc., on a mobile device using intuitive hand gestures without touching, wearing or holding any additional devices. Further, the techniques described herein reduce the frequency of user contact with a mobile device, alleviating wear on device surfaces. Additionally, techniques are described for reducing the power consumption associated with gesture recognition by controlling the operation of the IR emitters and/or proximity sensors based on ambient light conditions, executing applications, the presence or absence of anticipated user inputs, or other parameters relating to a mobile device for which contactless gesture recognition is employed. These techniques are examples only and are not limiting of the disclosure or the claims.

Referring to FIG. 1, a device 10 (e.g., a mobile device or other suitable computing device) comprises a computer system including a processor 12, memory 14 including software 16, input/output devices 18 (e.g., a display, speaker, keypad, touch screen or touchpad, etc.) and one or more sensor systems 20. Here, the processor 12 is an intelligent hardware device, e.g., a central processing unit (CPU) such as those made by Intel® Corporation or AMD®, a microcontroller, an application specific integrated circuit (ASIC), etc. The memory 14 includes non-transitory storage media such as random access memory (RAM) and read-only memory (ROM). Additionally or alternatively, the memory 14 can include one or more physical and/or tangible forms of non-transitory storage media including, for example, a floppy disk, a hard disk, a CD-ROM, a Blu-Ray disc, any other optical medium, an EPROM, a FLASH-EPROM, any other memory chip or cartridge, or any other non-transitory medium from which a computer can read instructions and/or code. The memory 14 stores the software 16, which is computer-readable, computer-executable software code containing instructions that are configured to, when executed, cause the processor 12 to perform various functions described herein. Alternatively, the software 16 may not be directly executable by the processor 12 but is configured to cause the computer, e.g., when compiled and executed, to perform the functions.

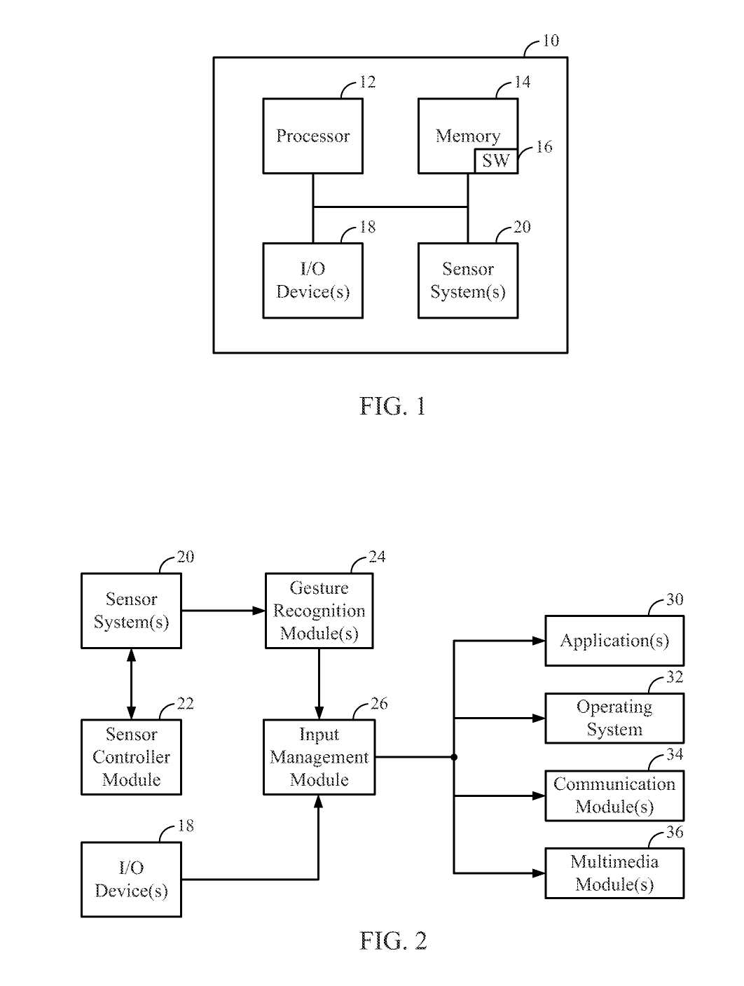

The sensor systems 20 are configured to collect data relating to the proximity of one or more objects (e.g., a user's hand, etc.) to the device 10 as well as changes to the proximity of such objects over time. Referring also to FIG. 2, the sensor systems 20 are utilized in connection with one or more gesture recognition modules 24 that are configured to detect, recognize and classify user gestures. Detected and classified gestures are provided to an input management module 26 that maps the gestures to basic commands that are utilized, in combination with or independently of other inputs received from I/O devices 18, by various modules or systems associated with the device 10. For example, input management module 26 can control inputs to applications 30, an operating system 32, communication modules 34, multimedia modules 36, and/or any other suitable systems or modules executed by the device 10.

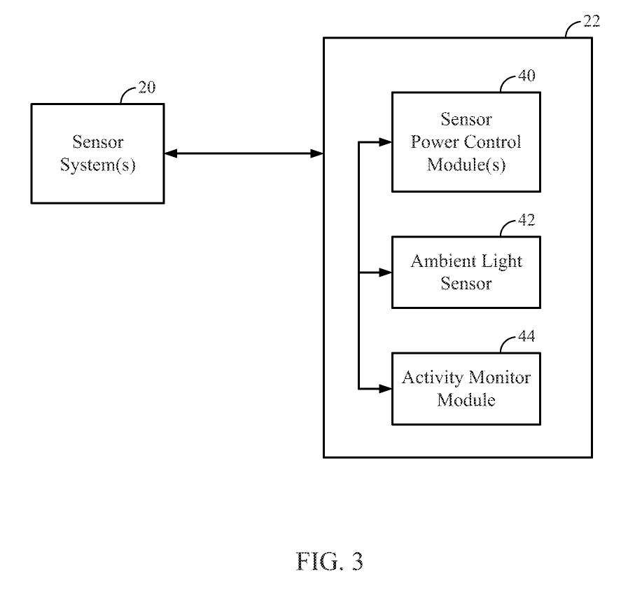

A sensor controller module 22 is further implemented to control the operation of the sensor systems 20 based on parameters of the device 10. For example, based on device orientation, ambient light conditions, user activity, etc., the sensor controller module 22 can control the power level of at least some of the sensor systems 20 and/or individual components of the sensor systems 20 (e.g., IR emitters, IR sensors, etc.), as shown by FIG. 3. Here, the sensor controller module 22 implements one or more sensor power control modules 40 that manage the power levels of respective sensor systems 20. For example, an ambient light sensor 42 can utilize light sensors and/or other mechanisms for measuring the intensity of ambient light at the location of the device 10. The sensor power control module(s) 40 can utilize these measurements to adjust the light accordingly, e.g., by increasing the power level of one or more sensor systems 20 when substantially high ambient light levels are detected or lowering the power level of one or more sensor systems 20 when lower ambient light levels are detected.

As another example, an activity monitor 44 can collect information relating to the extent of user interaction with the device 10, in the context of the device 10 generally and/or specific applications 30 implemented by the device 10 that utilize input via the sensor systems 20. The sensor power control module(s) 40 can then utilize this information by adjusting the power level of the sensor systems 20 according to the user activity level, e.g., by increasing power as activity increases or decreasing power as activity decreases. In the event that a user does not provide gesture input via the sensor systems 20 within a given amount of time, one or more gesture recognition applications are not open at the device 10, the device 10 is operating in an idle mode, and/or other triggering conditions are met, the sensor power control module(s) 40 can additionally place one or more sensor systems 20 into a slotted mode or another power saving mode until one or more gesture recognition applications are opened and/or user activity with respect to the device 10 increases.

In addition to information provided by the ambient light sensor 42 and the activity monitor 44, the sensor power control module(s) 40 are operable to adjust the power level(s) of the sensor system(s) 20 based on any other suitable parameters or metrics. For example, a camera and/or a computer vision system can be employed at the device 10, based on which the sensor power control module(s) 40 can increase power to the sensor systems 20 when an approaching user is identified. As another example, the sensor power control module(s) 40 can monitor the orientation of the device 10 (e.g., via information collected from an accelerometer, a gyroscope, and/or other orientation sensing devices) and activate and/or deactivate respective sensor systems 20 associated with the device 10 according to its orientation. Other parameters of the device 10 are also usable by the sensor power control module(s) 40.

Sensor systems 20 enable the use of gesture-based interfaces for a device 10, which provide an intuitive way for users to specify commands and interact with computers. The intuitive user interface facilitates use by more people, of varying levels of technical abilities, and use with size and resource-constrained devices.

Existing gesture recognition systems can be classified into three types: motion-based, touch-based, and vision-based systems. Motion-based gesture recognition systems interpret gestures based on movement of an external controller held by a user. However, a user cannot provide gestures unless holding or wearing the external controller. Touch-based systems map the position(s) of contact point(s) on a touchpad, touchscreen, or the like, from which gestures are interpreted based on changes to the mapped position(s). Due to the nature of touch-based systems, they are incapable of supporting three-dimensional gestures since all possible gestures are confined within the two-dimensional touch surface. Further, touch-based systems require a user to contact the touch surface in order to provide input, which reduces usability and causes increased wear to the touch surface and its associated device. Vision-based gesture recognition systems utilize a camera and/or a computer vision system to identify visual gestures made by a user. While vision-based systems do not require a user to contact an input device, vision-based systems are typically associated with high computational complexity and power consumption, which is undesirable for resource-limited mobile devices such as tablets or mobile phones.

The techniques described herein provide for contactless gesture recognition. The techniques employ IR lights, e.g., IR light emitting diodes (LEDs), and IR proximity sensors along with algorithms to detect, recognize, and classify hand gestures and to map the gesture into command(s) that are expected by an associated computing device application.

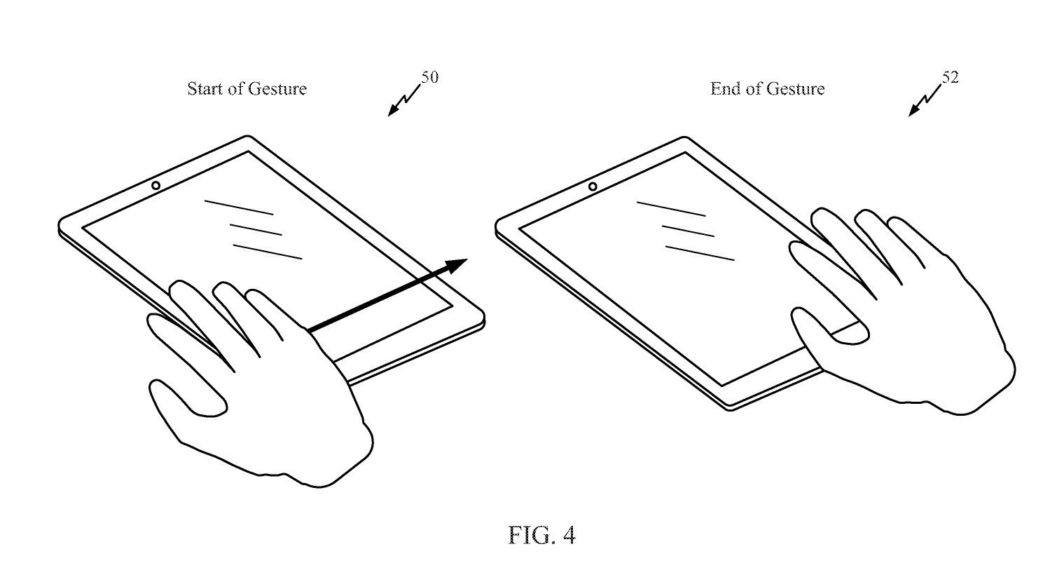

An example of the concept of operation of a contactless gesture recognition system is illustrated in FIG. 4. As shown in diagrams 50 and 52, a user is moving a hand from left to right in front of a computing device to perform a “right swipe” gesture. This “right swipe” could represent, e.g., a page turn for an e-reader application and/or any other suitable operation(s), as further described herein.

A gesture recognition system including sensor systems 20, sensor controller module 22, and/or other mechanisms as described herein can preferably, though not necessarily, provide the following capabilities. First, the system can automatically detect gesture boundaries. A common challenge of gesture recognition is the uncertainty of the beginning and ending of a gesture. For instance, a user can indicate the presence of a gesture without pressing a key. Second, the gesture recognition system can recognize and classify gestures in a substantially real-time manner. The gesture interface is preferably designed to be responsive such that no time-consuming post-processing is performed. Third, false alarms are preferably reduced, as executing an incorrect command is generally worse than missing a command. Fourth, no user-dependent model training process is employed for new users. Although supervised learning can improve the performance for a specific user, collecting training data can be time consuming and undesirable for users.

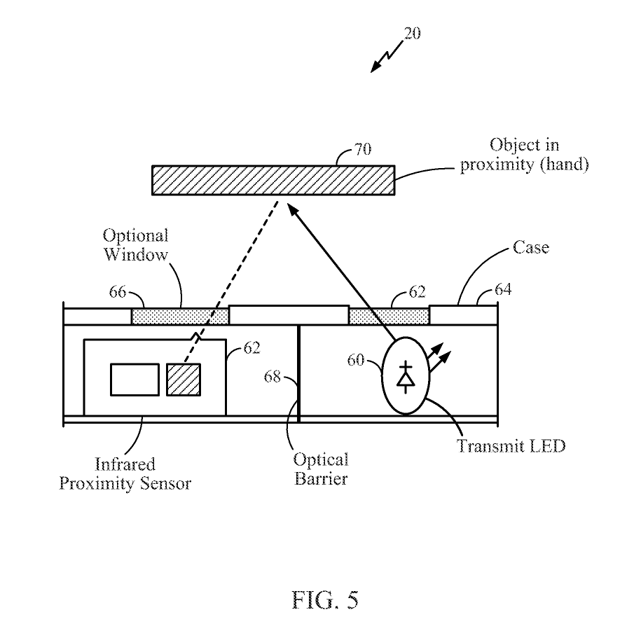

FIG. 5 shows an illustrative example of a sensor system 20 that utilizes an IR LED 60 and proximity sensor 62, which are placed underneath a case 64. The case 64 is composed of glass, plastic, and/or another suitable material. The case includes optical windows 66 that are constructed such that IR light is able to pass through the optical windows 66 substantially freely. The optical windows 66 can be transparent or covered with a translucent or otherwise light-friendly paint, dye or material, e.g., in order to facilitate a uniform appearance between the case 64 and the optical windows 66. Here, the IR LED 60 and proximity sensor 62 are positioned in order to provide substantially optimal light emission and reflection. An optical barrier 68 composed of light-absorbing material is placed between the IR LED 60 and the proximity sensor 62 to avoid spillage of light directly from the IR LED 60 to the proximity sensor 62.

FIG. 5 further illustrates an object 70 (e.g., a hand) in proximity to the light path of the IR LED 60, causing the light to be reflected back to the proximity sensor 62. The IR light energy detected by the proximity sensor 62 is measured, based on which one or more appropriate actions are taken. For example, if no object is determined to be close enough to the sensor system, the measured signal level will fall below pre-determined threshold(s) and no action is recorded. Otherwise, additional processing is performed to classify the action and map the action into one of the basic commands expected by a device 10 associated with the sensor system 20, as explained in further detail below.

The sensor system 20 can alternatively include two IR LEDs 60, which emit IR strobes in turns as two separate channels using time-division multiplexing. When an object 70 nears the sensor system 20, the proximity sensor 62 detects the reflection of the IR light, whose intensity increases as the object distance decreases. The light intensities of the two IR channels are sampled at a predetermined frequency (e.g., 100 Hz).

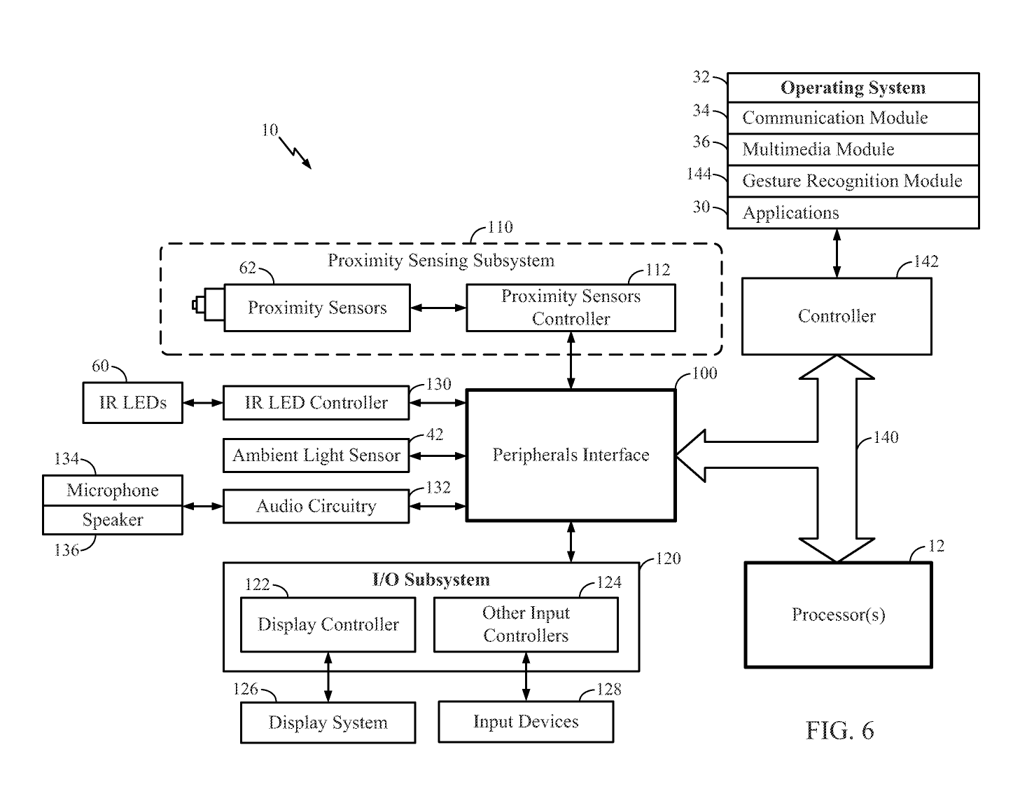

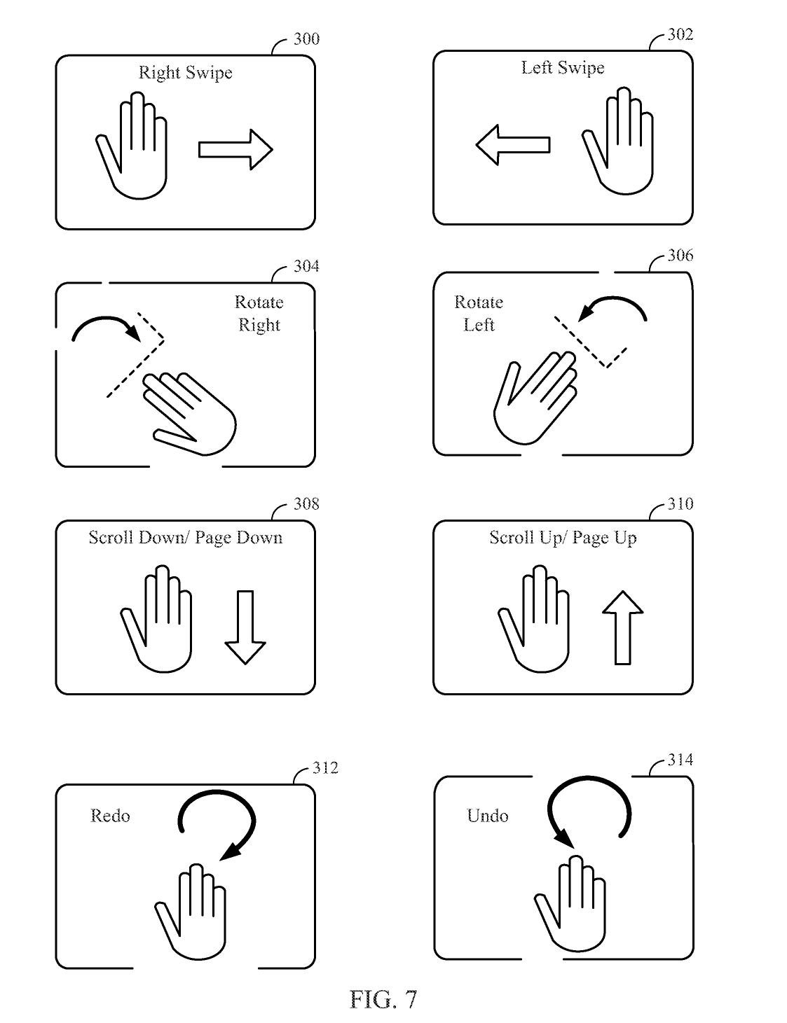

FIG. 6 illustrates various components that can be implemented by a device 10 that implements contactless gesture detection and recognition. The device 10 includes a peripherals interface 100 that provides basic management functionality for a number of peripheral subsystems. These subsystems include a proximity sensing subsystem 110, which includes a proximity sensor controller 112 and one or more proximity sensors 62, as well as an I/O subsystem 120 that includes a display controller 122 and other input controllers 124. The display controller 122 is operable to control a display system 126, while the other input controllers 124 are used to manage various input devices 128. The peripherals interface 100 further manages an IR LED controller 130 that controls one or more IR LEDs 60, an ambient light sensor 42, audio circuitry 132 that is utilized to control a microphone 134 and/or speaker 136, and/or other devices or subsystems. The peripherals interface is coupled via a data bus 140 to a processor 12 and a controller 142. The controller serves as an intermediary between the hardware components shown in FIG. 6 and various software and/or firmware modules, including an operating system 32, a communication module 36, a gesture recognition module 144, and applications 30.

A number of intuitive hand gestures can be utilized by a user of a device 10 as methods to activate respective basic commands on the device 10. Examples of typical hand gestures that can be utilized are as follows. The example gestures that follow, however, are not an exhaustive list and other gestures are possible. A swipe left gesture can be performed by starting the gesture with a user's hand above and at the right side of the device 10 and quickly moving the hand over the device 10 from right to left (e.g., as if turning pages in a book). The swipe left gesture can be used for, e.g., page forward or page down operations when viewing documents, panning the display to the right, etc. A swipe right gesture can be performed by moving the user's hand in the opposite direction and can be utilized for, e.g., page backward or page up operations in a document, display panning, or the like.

A swipe up gesture can be performed by starting the gesture with a user's hand above and at the bottom of the device 10 and quickly moving the hand over the device 10 from the bottom of the device 10 to the top (e.g., as if turning pages on a clipboard). The swipe up gesture can be used for, e.g., panning a display upwards, etc. A swipe down gesture, which can be performed by moving the user's hand in the opposite direction, can be utilized for panning a display downward and/or for other suitable operations. Additionally, a push gesture, which can be performed by quickly moving a user's hand vertically down and toward the device 10, and a pull gesture, which can be performed by quickly moving the user's hand vertically up and away from the device 10, can be utilized for controlling display magnification level (e.g., push to zoom in, pull to zoom out, etc.) or for other suitable uses.

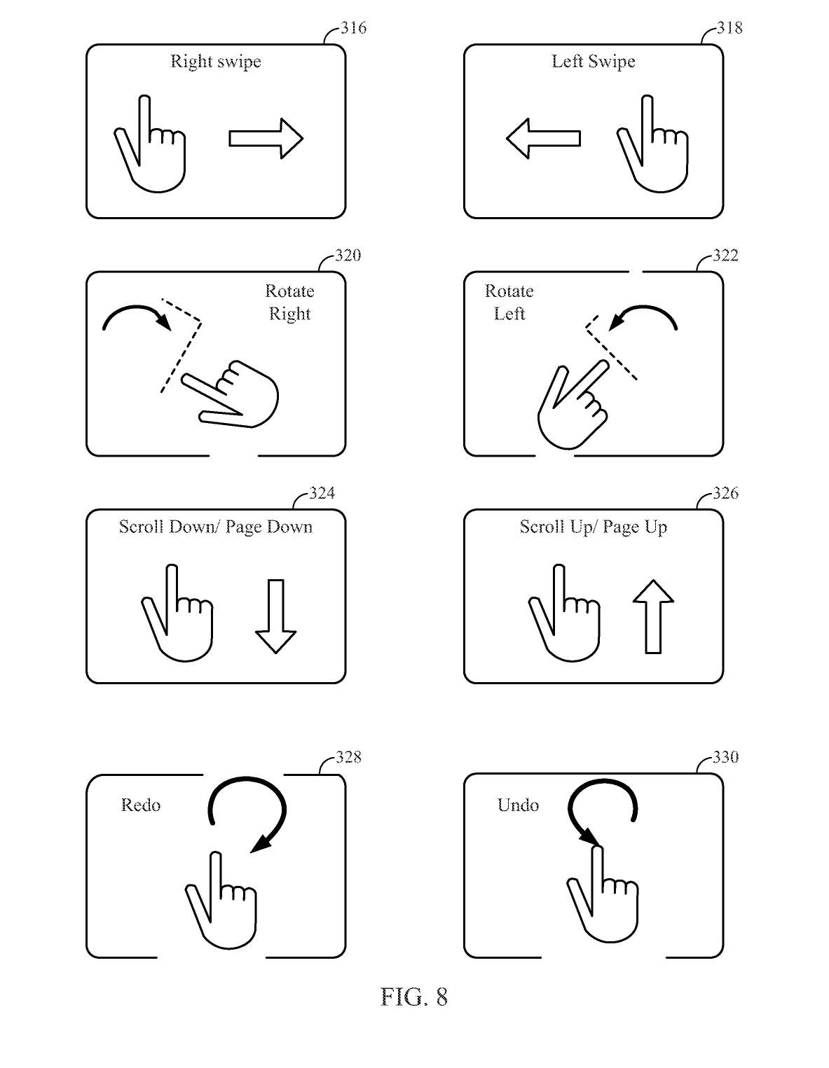

FIGS. 7-10 provide additional illustrations of various hand gestures that can be performed in association with a given command to a device 10. As shown by FIGS. 7-10, more than one gesture can be assigned to the same function, since a number of hand gestures may intuitively map to the same command. Depending on an application being executed, one, some or all of the hand gestures that map to a given command can be utilized.

With specific reference to FIG. 7, diagrams 300 and 302 respectively illustrate the right swipe and left swipe gestures described above. Diagram 304 illustrates a rotate right gesture that is performed by rotating a user's hand in a counterclockwise motion, while diagram 306 illustrates a rotate left gesture performed by rotating a user's hand in a clockwise motion. Diagrams 308 and 310 respectively illustrate the swipe down and swipe up gestures described above. Diagram 312 illustrates a redo gesture that is performed by moving a user's hand in a clockwise motion (i.e., as opposed to rotating the user's hand clockwise as in the rotate left gesture), and diagram 314 illustrates an undo gesture performed by moving a user's hand in a counterclockwise motion.

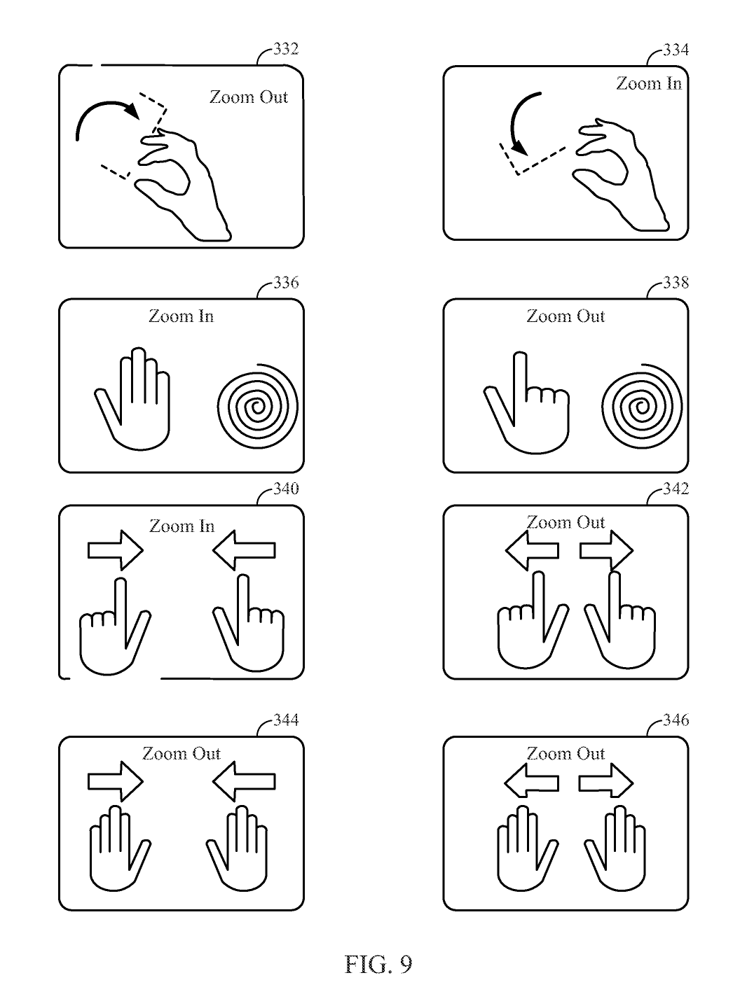

As shown in FIG. 8, gestures that are similar to those illustrated in FIG. 7 can be performed by moving a user's finger as opposed to requiring movement of the user's entire hand. Thus, the right swipe gesture illustrated by diagram 316, the left swipe gesture illustrated by diagram 318, the rotate right gesture illustrated by diagram 320, the rotate left gesture illustrated by diagram 322, the swipe down gesture illustrated by diagram 324, the swipe up gesture illustrated by diagram 326, the redo gesture illustrated by diagram 328 and the undo gesture illustrated by diagram 330 can be performed by moving a user's finger in a similar manner to the manner in which the user's hand is moved in the respective counterpart gestures illustrated by FIG. 7.

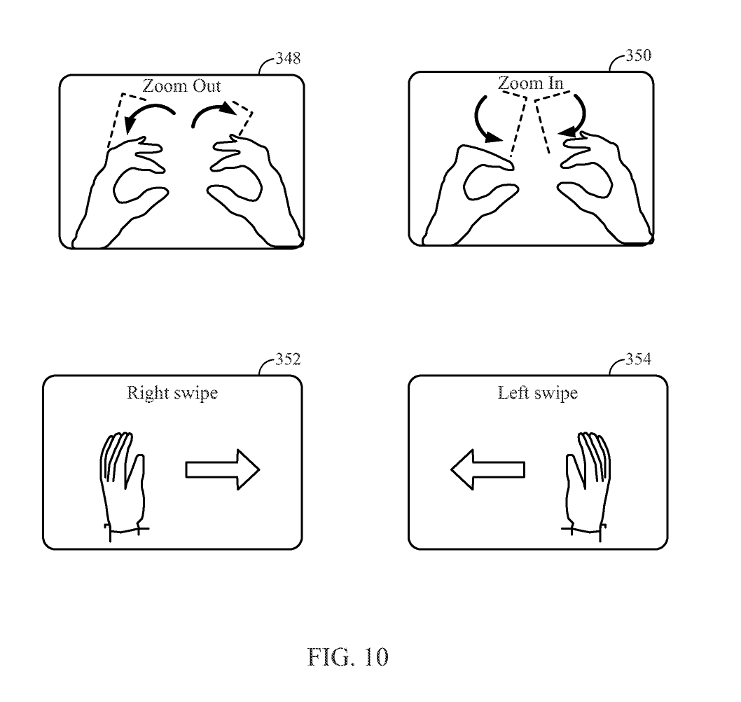

FIG. 9 illustrates various methods in which zoom in and zoom out gestures can be performed. Diagram 332 illustrates that a zoom out gesture can be performed by placing a user's hand in front of a sensor system 20 and moving the user's fingers outward. Conversely, diagram 334 illustrates that a zoom in gesture can be performed by bringing a user's fingers together in a pinching motion. Diagrams 336 and 338 illustrate that zoom in and/or zoom out gestures can be performed by moving a user's hand or finger in a spiral motion in front of a sensor system 20. Diagrams 340 and 342 illustrate that zooming can be controlled by moving a user's fingers together (for zooming in) or apart (for zooming out), while diagrams 344 and 346 illustrate that similar zoom in and zoom out gestures can be performed by moving a user's hands. The zoom out and zoom in gestures respectively illustrated by diagrams 332 and 334 can further be extended to two hands, as respectively illustrated by diagrams 348 and 350 in FIG. 10. Diagrams 352 and 354 of FIG. 10 further illustrate that right swipe and left swipe gestures can be performed by moving a user's hand across a sensor system 20 such that the side of the user's hand faces the sensor system 20.

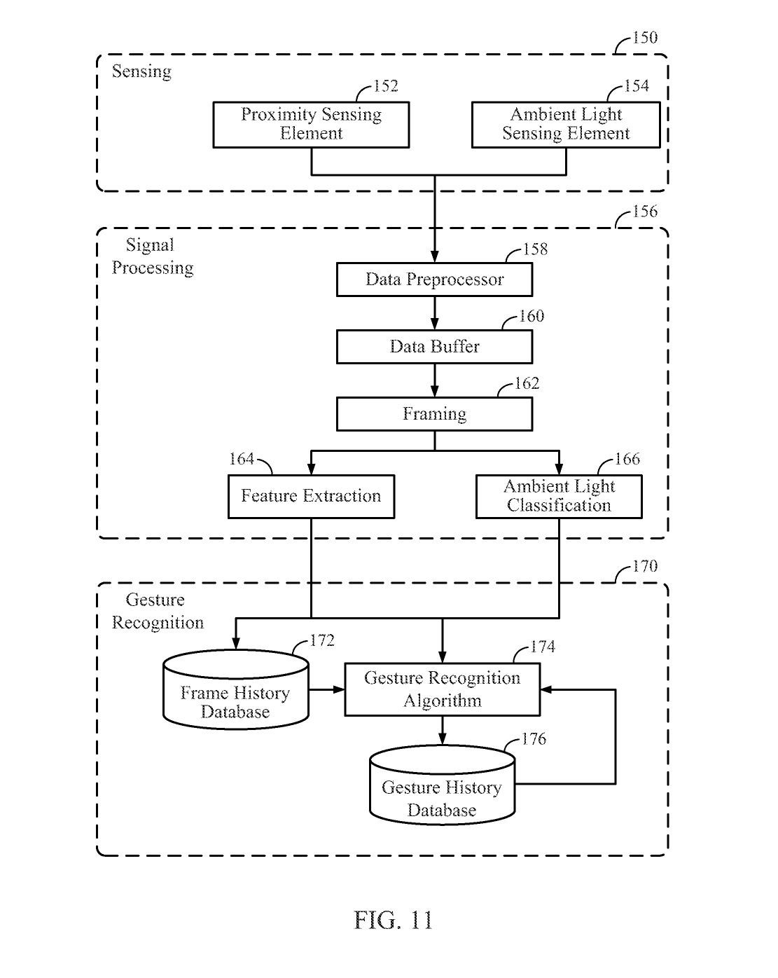

Operation of the sensor system 20 can be subdivided into a sensing subsystem 150, a signal processing subsystem 156 and a gesture recognition subsystem 170, as shown by FIG. 11. The sensing subsystem 150 utilizes a proximity sensing element 152 and an ambient light sensing element 154 to perform the functions of light emission and detection. The level of the detected light energy is passed to the signal processing subsystem 156, which performs front-end preprocessing of the energy level via a data preprocessor 158, data buffering via a data buffer 160, chunking the data into frames via a framing block 162, and extracting relevant features via a feature extraction block 164. The signal processing subsystem 156 further includes an ambient light classification block 166 to process data received from the sensing subsystem 150 relating to ambient light levels. The gesture recognition subsystem 170 applies various gesture recognition algorithms 174 to classify gestures corresponding to the features identified by the signal processing subsystem 156. Gesture historical data from a frame data history 172 and/or a gesture history database 176 can be used to improve the recognition rate, allowing the system continually to learn and improve the performance.

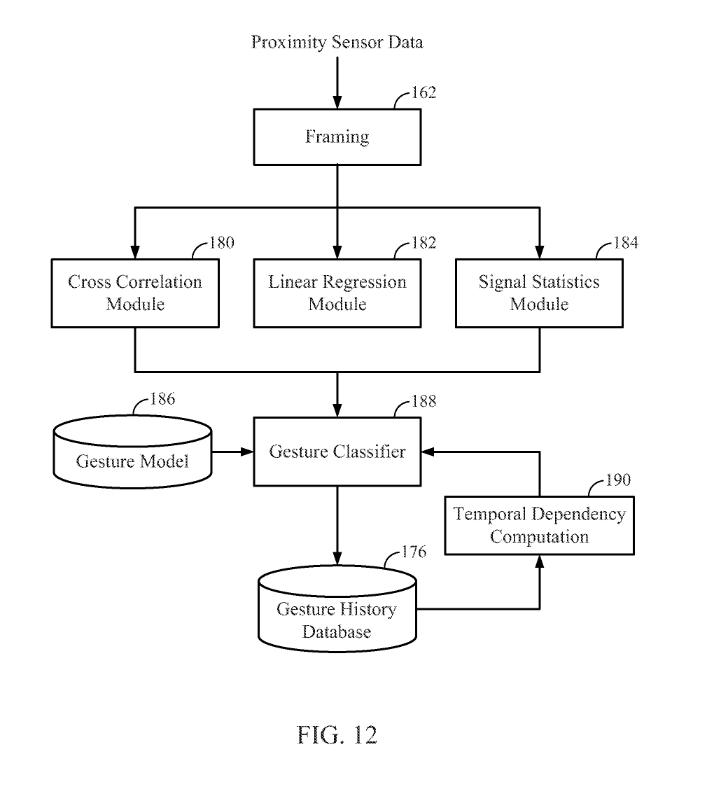

A general framework of the gesture recognition subsystem 170 is shown in FIG. 12. Proximity sensor data is initially provided to a framing block 162 that partitions the proximity sensor data into frames for further processing. As the start and end of respective gestures are not specified by the user, the gesture recognition subsystem 170, with the aid of the framing block 162, can utilize a moving window to scan the proximity sensor data and determine whether gesture signatures are observed. Here, the data are divided into frames of a specified duration (e.g., 140 ms) with 50% overlap. After framing, a cross correlation module 180, a linear regression module 182, and a signal statistics module 184 scan the frames of sensor data and determine whether a predefined gesture is observed. To discriminate the signal signatures of different gestures, these modules extract three types of features from each frame as follows.

The cross correlation module 180 extracts the inter-channel time delay, which measures the pair-wise time delay between two channels of proximity sensor data. The inter-channel time delay characterizes how a user's hand approaches the proximity sensors at different instants, which corresponds to different moving directions of the user's hand. The time delay is calculated by finding the maximum cross correlation value of two discrete signal sequences. In particular, a time delay t_{D}, can be calculated by finding the time shift n that yields a maximum cross correlation value of two discrete signal sequences f and g as follows:

$${t}_{D} = {arg max}_{n} {\sum }_{m = - ∞}^{∞} {f}^{*} ( m ) g ( m + n ) .$$

The linear regression module 182 extracts the local sum of slopes, which estimates the local slope of the signal segment within a frame. The local sum of slopes indicates the speed at which the user's hand is moving toward or away from the proximity sensors. The slope is calculated by linear regression, e.g., first-order linear regression. Further, the linear regression result may be summed with the slopes calculated for previous frames in order to capture the continuous trend of slopes as opposed to sudden changes.

The signal statistics module 184 extracts the mean and standard deviation of the current frame and the history of previous frames. A high variance can be observed, e.g., when a gesture is present, while a low variance can be observed, e.g., when the user's hand is not present or is present but not moving.

After feature extraction, a gesture classifier 188 classifies the frame as a gesture provided by a predefined gesture model 186 or reports that no gesture is detected. The final decision is made by analyzing the signal features in the current frame, historical data as provided by a gesture history database 176, and the temporal dependency between consecutive frames, as determined by a temporal dependency computation block 190. Temporal dependency between consecutive frames can be utilized in the gesture classification since a user is unlikely to change gestures swiftly. Further, the temporal dependency computation block 190 can maintain a small buffer (e.g., 3 frames) in order to analyze future frames prior to acting on a present frame. By limiting the size of the buffer, the temporal dependency can be maintained without imposing a noticeable delay to users.

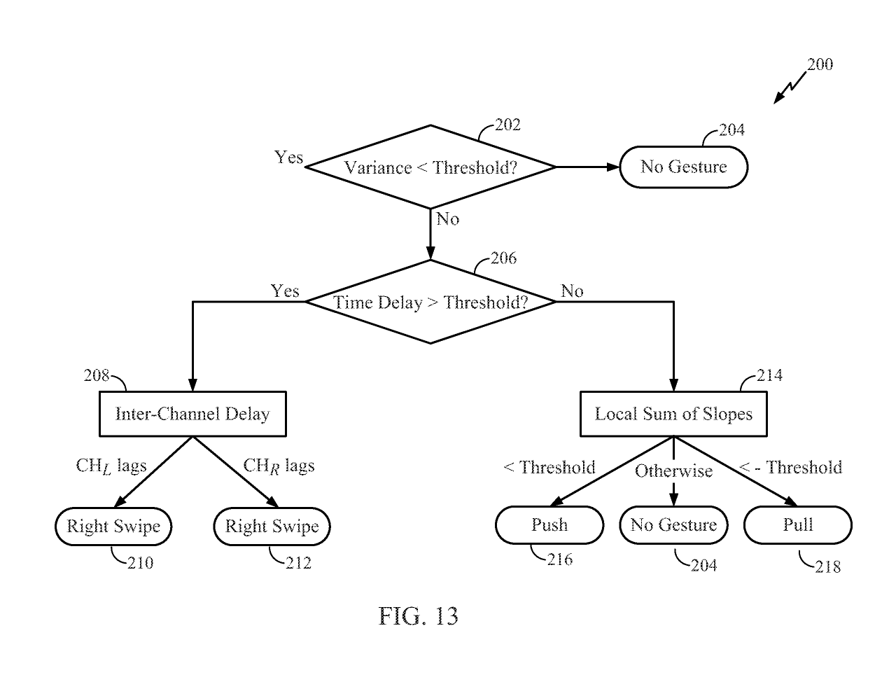

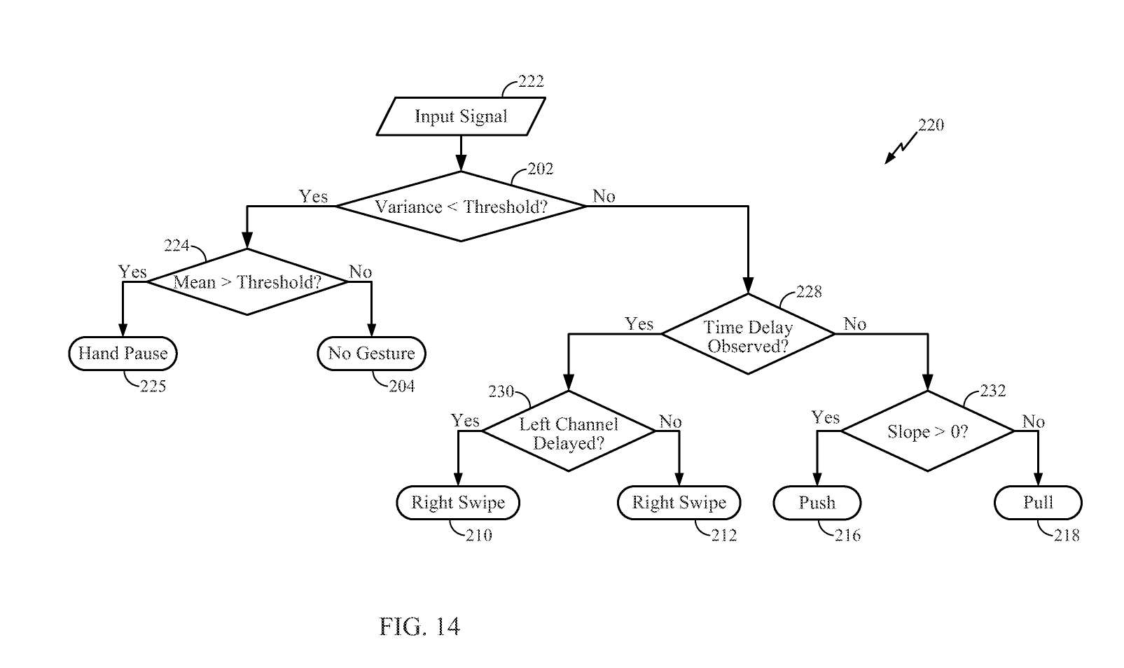

The gesture classifier can operate according to a decision tree-based process, such as process 200 in FIG. 13 or process 220 in FIG. 14. The processes 200 and 220 are, however, examples only and not limiting. The processes 200 and 220 can be altered, e.g., by having stages added, removed, rearranged, combined, and/or performed concurrently. Still other alterations to the processes 200 and 220 as shown and described are possible.

With reference first to process 200, it is initially determined whether the variance of the proximity sensor data is less than a threshold, as shown at block 202. If the variance is less than the threshold, no gesture is detected, as shown at block 204. Otherwise, at block 206, it is further determined whether a time delay associated with the data is greater than a threshold. If the time delay is greater than the threshold, the inter-channel delay of the data is analyzed at block 208. If the left channel is found to lag behind the right channel, a right swipe is detected at block 210. Alternatively, if the right channel lags behind the left channel, a left swipe is detected at block 212.

If the time delay is not greater than the threshold, the process 200 proceeds from block 206 to block 214 and a local sum of slopes is computed as described above. If the sum is greater than a threshold, a push gesture is detected at block 216. If the sum is less than the threshold, a pull gesture is detected at block 218. Otherwise, the process 200 proceeds to block 204 and no gesture is detected.

Referring next to process 220, the variance of an input signal 222 is compared to a threshold at block 202. If the variance is less than the threshold, the mean of the input signal 222 is compared to a second threshold at block 224. If the mean exceeds the threshold, a hand pause is detected at block 226; otherwise, no gesture is detected, as shown at block 204.

If the variance of the input signal 222 is not less than the threshold at block 202, the process 220 branches at block 228 based on whether a time delay is observed. If a time delay is observed, it is further determined at block 230 whether the left channel is delayed. If the left channel is delayed, a right swipe is detected at block 210; otherwise, a right swipe is detected at block 212.

In the event that a time delay is not observed at block 228, an additional determination is performed at block 232 regarding the slope associated with the input signal 222. If the slope is greater than zero, a push gesture is detected at block 216. If the slope is not greater than zero, a pull gesture is detected at block 218.

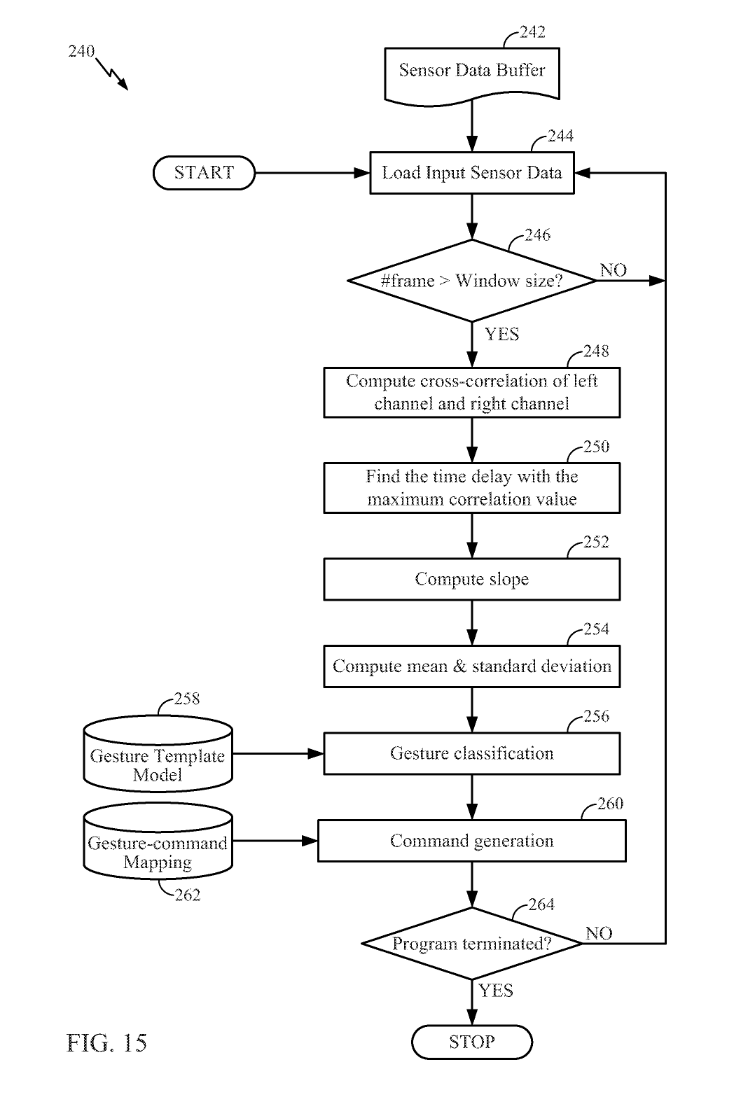

A further example of a decision tree-based gesture classifier is illustrated by process 240 in FIG. 15. The process 240 is, however, an example only and not limiting. The process 240 can be altered, e.g., by having stages added, removed, rearranged, combined, and/or performed concurrently. Still other alterations to the process 240 as shown and described are possible.

The process begins as shown at block 244 by loading input sensor data from a sensor data buffer 242. The present number of loaded frames is compared to a window size at block 246. If the number of frames is not sufficient, more input sensor data are loaded at block 244. Otherwise, at block 248, cross-correlations are computed of the left and right channels (e.g., corresponding to left and right IR proximity sensors). At block 250, the time delay with the maximum correlation value is found. A slope corresponding to the loaded sensor data is computed at block 252, and the mean and standard deviation of the sensor data are computed at block 254. Next, at block 256, gesture classification is performed for the loaded data based on the computations at blocks 248-254 with reference to a gesture template model 258. At block 260, an appropriate command is generated based on the gesture identified at block 256 based on a gesture-command mapping 262. At block 264, the process 240 ends if the corresponding gesture recognition program is terminated. Otherwise, the process 240 returns to block 244 and repeats the stages discussed above.

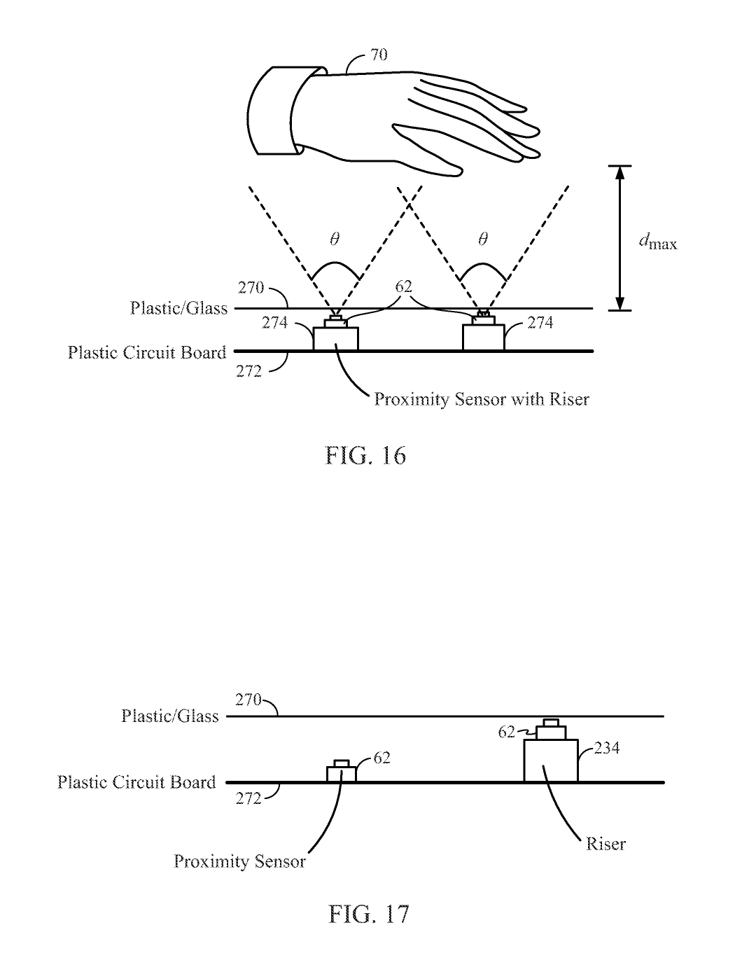

To facilitate proper operation as described herein, the IR LEDs and sensors can be placed on a computing device such that the reflection of light due to hand gestures can be detected and recognized. An example set of proximity sensors 62 can be placed between a plastic or glass casing 64 and a printed circuit board (PCB) 272, as shown in FIG. 16. Factors such as the placement of the components on the PCB 272, construction of apertures in the casing 64 that allow light to come through from the IR LED and allow light to reflect back in order to be able to be detected by the proximity sensor 62, the type of paint used for the casing 64 (e.g., if no aperture) that offer high light emission and absorption, among other factors, will increase the reliability of movement recognition.

The proximity sensors 62 can be positioned at a device 10 based on a variety of factors that impact the performance of the gesture recognition (e.g., with respect to a user's hand or other object 70). These include, for example, the horizontal distance between the IR LED and the proximity sensor 62, the height of the IR LED and the proximity sensor with respect to clearance, unintended light dispersion to the proximity sensor 62, etc.

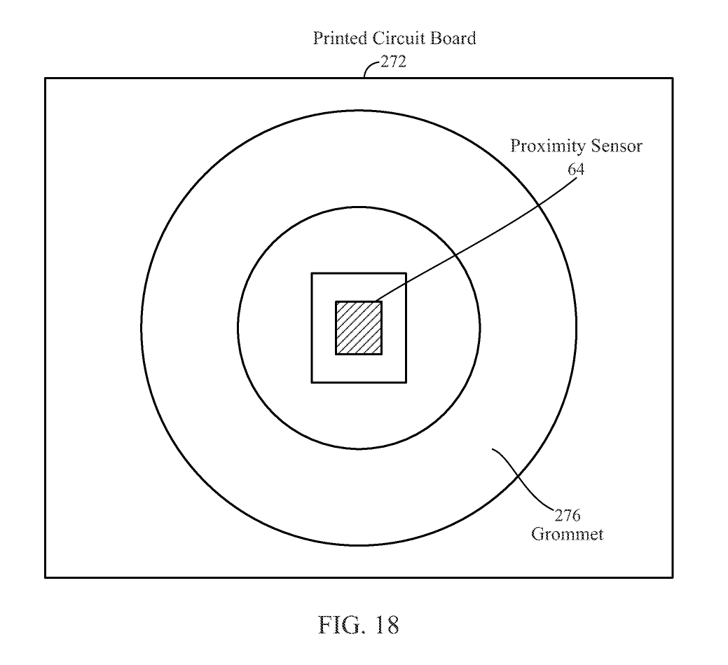

Sensors can be arranged such that both the height and the proper distance between the IR LED and the proximity sensor 62 enable good emission and reflectance of light. FIG. 16 and FIG. 17 illustrate a technique for ensuring proper height for respective sensor components. Here, a riser 274 is placed on top of the PCB 272 and the component, e.g., a proximity sensor 62, is mounted on top of the riser 274. Further, the surface of the casing 64 can have small apertures for light emission and reflectance, or alternatively IR-friendly paint can be applied to the surface of the casing 64 to allow light to pass through. By placing proximity sensors on risers 274 as shown in FIG. 16 and FIG. 17, the sensor components are brought closer to the surface, offering improved emission and reflectance angles. Additionally, the risers 274 mitigate unintentional light dispersion (e.g., caused by light bounced back from the casing 64) and reduce the power consumption of the sensor components.

FIG. 18 shows another approach for placement of sensor components, in which a grommet 276 is placed around the IR light and/or sensor. The approach shown by FIG. 18 can be combined with placement of risers 274 as described above. Here, the grommet 276 provides a mechanism for concentrating the beam (i.e., angle) of the emitted light and reducing the extent to which light reflects from the case back to the sensor (thereby degrading performance) in the event that there is no object placed on top of the IR light.

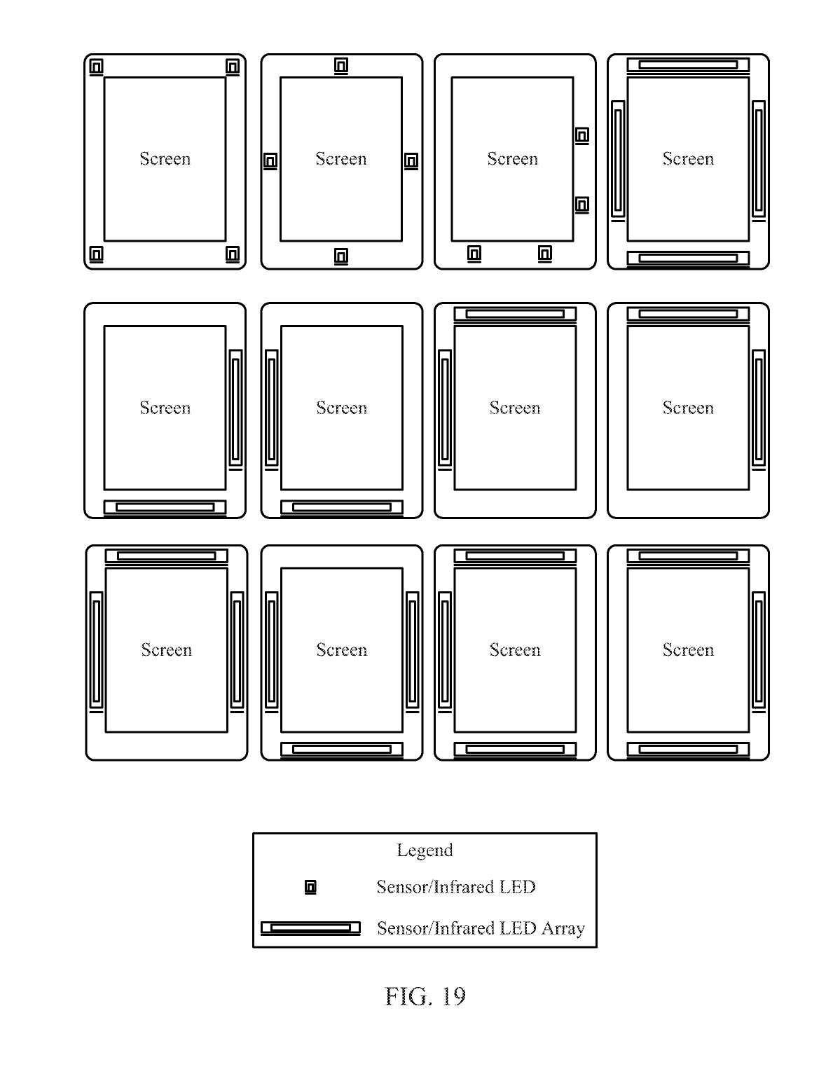

FIG. 19 illustrates a number of example placements for sensors and IR LEDs on a computing device, such as a device 10. While the various examples in FIG. 19 show sensor components placed at various positions along the edges of the computing device, the examples shown in FIG. 19 are not an exhaustive list of the possible configurations of placements and other placements, including placements along the front or back of the computing device and/or physically separate from the computing device, are also possible. Positioning and/or spacing of sensor components on a computing device, as well as the number of sensor components employed, can be determined according to various criteria. For example, a selected number of sensor components can be spaced such that the sensors provide sufficient coverage for classifying one-dimensional, two-dimensional and three-dimensional gestures.

Depending on the desired gestures, sensors and/or IR LEDs can be selectively placed along less than all edges of the computing device. As an example, if only left and right swipes are desired, placement of the IR LEDs and sensors on the bottom edge of the computing device may be regarded as adequate, with the assumption that the device will be used in portrait mode only. As an alternative, sensors can be placed along each edge of the computing device, and a control mechanism (e.g., sensor controller module 22) can selectively activate or deactivate sensors based on the orientation of the computing device. Thus, as an extension of the example given above, the sensor controller module 22 can configure operation of sensors associated with a computing device such that sensors associated with the top and bottom edges of the device are activated regardless of the orientation of the device, while sensors associated with the left and right edges of the device are deactivated. This example is merely illustrative of the various techniques that can be employed by the sensor controller module 22 to activate, deactivate, or otherwise control sensors based on the orientation of the associated device and other techniques are possible.

In addition to the gesture recognition techniques described above, still other techniques are possible. For example, multiple sensor arrays can be employed to obtain additional information from sensor data. Additionally, by using the basic gesture set as building blocks, more compound three-dimensional gestures can be recognized as permutations of the basic gestures. Hidden Markov models can also be used to learn gesture sequences performed by users. Further, the techniques described herein can be applied to application-specific or game-specific use cases.

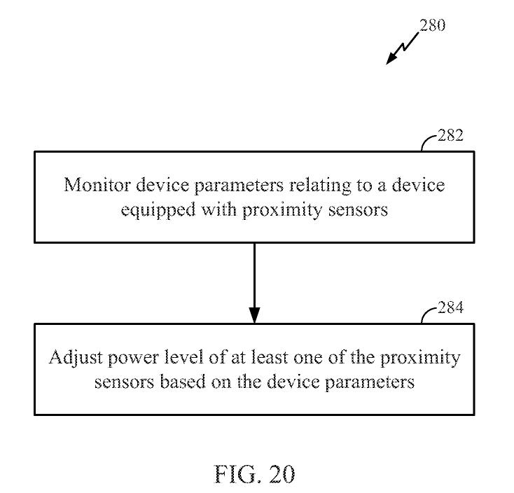

Referring to FIG. 20, with further reference to FIGS. 1-19, a process 280 of managing a contactless gesture recognition system includes the stages shown. The process 280 is, however, an example only and not limiting. The process 280 can be altered, e.g., by having stages added, removed, rearranged, combined, and/or performed concurrently. Still other alterations to the process 280 as shown and described are possible.

At stage 282, parameters are monitored that relate to a device equipped with proximity sensors, such as sensor systems 20 including IR LEDs 60 and proximity sensors 62. The parameters can be monitored by a sensor controller module 22 implemented by a processor 12 executing software 16 stored on a memory 14 and/or any other mechanisms associated with the proximity sensors. Parameters that can be monitored at stage 282 include, but are not limited to, ambient light levels (e.g., as monitored by an ambient light sensor 42), user activity levels (e.g., as determined by an activity monitor 44), device orientation, identities of applications currently executing on the device and/or applications anticipated to be executed in the future, user proximity to the device (e.g., as determined based on data from a camera, computer vision system, etc.), or the like.

At stage 284, the power level of at least one of the proximity sensors is adjusted based on the parameters monitored at stage 282. The power level of the proximity sensors can be adjusted at stage 284 by a sensor power control module implemented by a processor 12 executing software 16 stored on a memory 14 and/or any other mechanisms associated with the proximity sensors. Further, the power level of the proximity sensors can be adjusted by, e.g., modifying the emission intensity of the IR LEDs 60 associated with the proximity sensors, modifying the duty cycle and/or sampling frequency of the proximity sensors (e.g., in the case of proximity sensors operating in a strobed mode), placing respective proximity sensors in an active, inactive, or idle mode, etc.

Still other techniques are possible.

What is claimed is:

1. A mobile computing device comprising:
a sensor system configured to obtain data relating to three-dimensional user movements, the sensor system comprising an infrared (IR) light emitting diode (LED) and an IR proximity sensor; and
a sensor controller module communicatively coupled to the sensor system and configured to identify properties of the device indicative of clarity of the data relating to the three-dimensional user movements obtained by the sensor system and probability of correct input gesture identification with respect to the three-dimensional user movements and to regulate power consumption of at least one of the IR LED or the IR proximity sensor of the sensor system based on the properties of the device.

2. The device of claim 1 further comprising an ambient light sensor communicatively coupled to the sensor controller module and configured to identify an ambient light level of an area at which the device is located, wherein the sensor controller module is further configured to adjust a power level of the IR LED according to the ambient light level.

3. The device of claim 1 further comprising an activity monitor module communicatively coupled to the sensor controller module and configured to determine a level of user activity with respect to the device, wherein the sensor controller module is further configured to regulate the power consumption of the sensor system according to the level of user activity.

4. The device of claim 3 wherein the sensor controller module is further configured to place the sensor system in a slotted operating mode if the level of user activity is determined to be below a predefined threshold.

5. The device of claim 1 wherein the device comprises at least two front-facing edges, IR LEDs and IR proximity sensors of the sensor system are positioned on at least two of the front-facing edges of the device, the properties of the device comprise orientation of the device, and the sensor controller module is further configured to selectively activate IR LEDs and IR proximity sensors positioned on at least one of the front-facing edges of the device based on the orientation of the device.

6. The device of claim 1 wherein the device further comprises:
at least one front-facing edge; and
one or more apertures positioned along the at least one front-facing edge;
wherein the one or more apertures are covered with an IR transmissive material and one of an IR LED or an IR proximity sensor of the sensor system is positioned behind each of the one or more apertures.

7. The device of claim 1 wherein the sensor system further comprises risers respectively coupled to the IR LED and the IR proximity sensor such that the IR LED and the IR proximity sensor are elevated by the risers.

8. The device of claim 1 further comprising:
a framing module communicatively coupled to the sensor system and configured to partition the data obtained by the sensor system into frame intervals;
a feature extraction module communicatively coupled to the framing module and the sensor system and configured to extract features from the data obtained by the sensor system; and
a gesture recognition module communicatively coupled to the sensor system, the framing module and the feature extraction module and configured to identify input gestures corresponding to respective ones of the frame intervals based on the features extracted from the data obtained by the sensor system.

9. The device of claim 8 wherein the gesture recognition module is further configured to identify the input gestures based on at least one of cross correlation, linear regression or signal statistics.

10. The device of claim 1 wherein the sensor system is configured to obtain the data relating to the three-dimensional user movements with reference to a plurality of moving objects.

11. A method of managing a gesture-based input mechanism for a computing device, the method comprising:
identifying parameters of the computing device relating to accuracy of gesture classification performed by the gesture-based input mechanism; and
managing a power consumption level of at least an infrared (IR) light emitting diode (LED) or an IR proximity sensor of the gesture-based input mechanism based on the parameters of the computing device.

12. The method of claim 11 wherein the identifying comprises identifying an ambient light level of an area associated with the computing device and the managing comprises adjusting a power level of the IR LED according to the ambient light level.

13. The method of claim 11 wherein the identifying comprises determining a level of user interaction with the computing device via the gesture-based input mechanism and the managing comprises:
comparing the level of user interaction to a threshold; and
placing the gesture-based input mechanism in a power saving mode if the level of user interaction is below the threshold.

14. The method of claim 11 wherein the identifying comprises identifying an orientation of the computing device and the managing comprises activating or deactivating the IR LED or the IR proximity sensor based on the orientation of the computing device.

15. The method of claim 11 further comprising:
obtaining sensor data from the gesture-based input mechanism;
partitioning the sensor data in time, thereby obtaining respective frame intervals;
extracting features from the sensor data; and
classifying gestures represented in respective ones of the frame intervals based on the features extracted from the sensor data.

16. The method of claim 15 wherein the classifying comprises classifying the gestures represented in the respective ones of the frame intervals based on at least one of cross correlation, linear regression or signal statistics.

17. The method of claim 15 wherein the obtaining comprises obtaining sensor data relating to a plurality of moving objects.

18. A mobile computing device comprising:
sensor means configured to obtain infrared (IR) light-based proximity sensor data relating to user interaction with the device; and
controller means communicatively coupled to the sensor means and configured to identify properties of the device and to manage power consumption of at least part of the sensor means based on the properties of the device.

19. The device of claim 18 wherein the controller means is further configured to measure an ambient light level at an area associated with the device and to adjust the power consumption of at least part of the sensor means based on the ambient light level.

20. The device of claim 18 wherein the controller means is further configured to determine an extent of the user interaction with the device and to adjust the power consumption of at least part of the sensor means according to the extent of the user interaction with the device.

21. The device of claim 20 wherein the controller means is further configured to power off the sensor means upon determining that no user interaction with the device has been identified by the sensor means within a time interval.

22. The device of claim 20 wherein the controller means is further configured to place the sensor means in a power save operating mode if the extent of the user interaction with the device is below a threshold.

23. The device of claim 18 wherein the sensor means comprises a plurality of sensor elements, and the controller means is further configured to selectively activate one or more of the plurality of sensor elements based on an orientation of the device.

24. The device of claim 18 further comprising gesture means communicatively coupled to the sensor means and configured to classify the proximity sensor data by identifying input gestures represented in the proximity sensor data.

25. A computer program product residing on a non-transitory processor-readable medium and comprising processor-readable instructions configured to cause a processor to:
obtain three-dimensional user movement data from an infrared (IR) proximity sensor associated with a mobile device that measures reflection of light from an IR light emitting diode (LED);
identify properties of the mobile device indicative of accuracy of the three-dimensional user movement data; and
regulate power usage of at least a portion of the IR LEDs and IR proximity sensors based on the properties of the mobile device.

26. The computer program product of claim 25 wherein the parameters of the mobile device comprise an ambient light level at an area associated with the mobile device.

27. The computer program product of claim 25 wherein the parameters of the mobile device comprise a history of user interaction with the mobile device.

28. The computer program product of claim 25 wherein the parameters of the mobile device comprise an orientation of the mobile device.

29. The computer program product of claim 25 wherein the instructions configured to cause the processor to detect the one or more gestures are further configured to cause the processor to:
group the three-dimensional user movement data according to respective frame time intervals;
extract features from the three-dimensional user movement data; and
identify input gestures provided within respective ones of the frame time intervals based on the features extracted from the three-dimensional user movement data.

30. The computer program product of claim 29 wherein the instructions configured to cause the processor to identify input gestures are further configured to cause the processor to identify the input gestures based on at least one of cross correlation, linear regression or signal statistics.
